(19) United States
(12) Patent Application Publication
(10) Pub. No.: US 2006/0101299 A1
(43) Pub. Date: May 11, 2006

(54) Controller for instruction cache and instruction translation look-aside buffer, and method of controlling the same

(76) Inventor: Sung-Woo Chung, Seoul (KR)

Correspondence Address: F. CHAU & ASSOCIATES, LLC, 130 WOODBURY ROAD, WOODBURY, NY, 11797, US

(21) Appl. No.: 11/242,729

(22) Filed: Oct. 4, 2005

(30) Foreign Application Priority Data
Oct. 5, 2004 (KR) 2004-79246

(51) Int. Cl. G06F 15/00

(52) U.S. Cl. 713/324; 712/239; 712/238

(57) ABSTRACT

There are provided a controller for an instruction cache and an instruction TLB (Translation Look-aside Buffer), and a method of controlling the same. The controller includes: a processor core outputting an address of a current instruction; a branch predictor performing a branch prediction of the outputted current instruction address to output a final branch prediction value; a branch target buffer predicting a branch target address of the outputted current instruction address at the same time of the branch prediction of the branch predictor, to output a prediction target address; and an address selection unit selecting and outputting one of the prediction target address and the current instruction address where a branch prediction result is not “taken”, wherein the branch prediction and the branch target address prediction for the current instruction address are initiated, on the assumption that a previous instruction of the current instruction is not a branch instruction, before a branch prediction and a branch target address prediction for an address of the previous instruction are ended, and wherein the address outputted from the address selection unit wakes-up corresponding cache lines of the instruction cache and the instruction TLB, which use a dynamic voltage scaling.

### BACKGROUND OF THE INVENTION

This application claims the priority of Korean Patent Application No. 2004-0079246, filed on Oct. 5, 2004, in the Korean Intellectual Property Office, the disclosure of which is incorporated herein in its entirety by reference.

1. Field of the Invention

The present invention relates to a microprocessor, and more particularly, to a controller for controlling an instruction cache and an instruction Translation Look-aside Buffer (hereinafter, referred to as “instruction TLB”), which use a dynamic voltage scaling, and a method of controlling the same.

2. Description of the Related Art

Most of the power consumed by a microprocessor is due to an on-chip cache. As a line width (a feature size) is reduced, the majority of the power consumed by the microprocessor is leakage power in the on-chip cache. To solve this problem, a drowsy cache has been proposed.

FIG. 1 is a view illustrating the drowsy cache using a Dynamic Voltage Scaling (DVS). The drowsy cache of FIG. 1 is disclosed in 2002 at the International Symposium on Computer Architecture.

The drowsy cache uses a dynamic voltage scaling in which two different supply voltages are supplied to each cache line. The dynamic voltage scaling technology can reduce the leakage power consumption of the on-chip cache.

FIG. 2 is a graph illustrating a comparative result of power consumption of a regular cache and a drowsy cache.

As apparent from FIG. 2, the leakage power represents the total power consumption of the regular cache. In case of the drowsy cache, the leakage power is reduced according to the reduction of an operating voltage supplied to a cache line, and represents a small part of the total power consumption.

Referring again to FIG. 1, to implement the dynamic voltage scaling, the drowsy cache separately includes a drowsy bit, a voltage controller, and a wordline gating circuit.

The drowsy bit controls the voltage supplied to a memory cell included in Static Random Access Memories (SRAMs). The voltage controller determines a high supply voltage (1 volt) and a low supply voltage (0.3 volt) supplied to a memory cell array connected to the cache line, on the basis of a state of the drowsy bit. The wordline gating circuit is used to cut off an access to the cache line. The access to the cache line can destroy a content of a memory.

The drowsy cache is operated at 1 volt in a normal mode, and at 0.3 volt in a drowsy mode. The drowsy cache maintains a state of the cache line in the drowsy mode, but cannot stably perform a read operation and a write operation. Accordingly, the drowsy cache needs a mode switching from the drowsy mode to the normal mode to perform the read operation and the write operation. A time required for the mode switching is one cycle as a wake-up time (or wake-up transition latency). Accordingly, in the case where the cache line of the drowsy cache to be woken up is erroneously predicted, one cycle of a performance penalty (or wake-up penalty) is generated.

### SUMMARY OF THE INVENTION

The present invention provides a controller for an instruction cache and an instruction TLB, which can prevent (or eliminate) one cycle of penalty, and a method of controlling the same.

According to an aspect of the present invention, there is provided a controller for an instruction cache and an instruction TLB (Translation Look-aside Buffer), the controller including: a processor core outputting an address of a current instruction; a branch predictor performing a branch prediction of the outputted current instruction address to output a final branch prediction value; a branch target buffer predicting a branch target address of the outputted current instruction address at the same time as the branch predictor performs the branch prediction, to output a prediction target address; and an address selection unit selecting and outputting one of the prediction target address and the current instruction address where a branch prediction result is not “taken”, wherein the branch prediction and the branch target address prediction for the current instruction address are initiated, on the assumption that a previous instruction of the current instruction is not a branch instruction, before a branch prediction and a branch target address prediction for an address of the previous instruction are ended, and wherein the address outputted from the address selection unit wakes up corresponding cache lines of the instruction cache and the instruction TLB, which use a dynamic voltage scaling.

The address outputted from the address selection unit may wake up corresponding sub-banks of the instruction cache and the instruction TLB, which use the dynamic voltage scaling.

The address selection unit may operate in response to a least significant bit of the current instruction address and the final branch prediction value.

The address selection unit may include: an exclusive OR gate performing an exclusive OR operation on the least significant bit of the current instruction address and the final branch prediction value, to output a selection value; and a multiplexer selecting and outputting one of the current instruction address wherein the branch prediction result is not “taken” and the prediction target address, in response to the selection value.

The branch predictor may include: a global history register storing past branch prediction values for addresses of previous branch instructions; a first exclusive OR gate performing an exclusive OR operation on the current instruction address and the address stored in the global history register, to output an index value; a branch prediction table storing branch prediction values for the addresses of the past branch instructions, and outputting the branch prediction values for the current instruction address indexed by the index value; a second exclusive OR gate performing an exclusive OR operation on a least significant bit of the current instruction address and a least significant bit of the address stored in the global history register, to output a selection value; and a multiplexer outputting one of the branch prediction values as the final branch prediction value, in response to the selection value.

The branch predictor may further include an address register storing the current instruction address.

Two sequential entries included in one line of the branch prediction table may be indexed by the index value.

The branch target buffer may include: a branch target table storing target addresses for the addresses of the previous branch instructions indexed by virtual index bits of the current instruction address, and target tags corresponding to the target addresses; a first multiplexer outputting one of the target tags indexed by the virtual index bits, in response to a least significant bit of the current instruction address; a comparator comparing physical tag bits of the current instruction address with the outputted one of the target tags, to output an enable signal; a second multiplexer outputting one of the target addresses indexed by the virtual index bits, in response to the least significant bit of the current instruction address; and a buffer buffering the outputted one of the target addresses in response to the activation of the enable signal, to output the buffered target address as the prediction target address.

The branch target buffer may further include an address register storing the current instruction address.

The two sequential entries included in one line of the branch target table may be indexed by the virtual index bits.

According to another aspect of the present invention, there is provided a method of controlling an instruction cache and an instruction TLB (Translation Look-aside Buffer), the method including: (a) assuming that a previous instruction of a current instruction is not a branch instruction; (b) concurrently performing a branch prediction and a branch target address prediction for an address of the current instruction; (c) determining whether a branch prediction result of (b) is “taken”; (d) if it is determined in (c) that the branch prediction result is “taken”, waking up a cache line of the instruction cache and a cache line of the instruction TLB that is indexed by a prediction target address, the prediction target address being a result of the branch target address prediction of (b); and (e) if it is determined in (c) that the branch prediction result is not “taken”, waking up a cache line of the instruction cache and a cache line of the instruction TLB that is indexed by an address of a sequential current instruction, wherein the branch prediction and the branch target address prediction for the current instruction address are initiated before a branch prediction and a branch target address prediction for an address of the previous instruction are ended, and wherein the instruction cache and the instruction TLB use a dynamic voltage scaling.

The method may further include: concurrently transmitting the current instruction address from a processor core to a branch predictor performing the branch prediction and to a branch target buffer performing the branch target address prediction.

In (d), a sub-bank of the instruction cache and a sub-bank of the instruction TLB indexed respectively by the prediction target address may be woken up, and in (e), a sub-bank of an instruction cache and a sub-bank of the instruction TLB indexed respectively by the address of the sequential current instruction may be woken up.

Two sequential entries included in one line of a branch prediction table used for performing the branch prediction of (b) may be indexed by one index value.

The two sequential entries included in one line of a branch prediction table used for performing the branch target address prediction of (b) may be indexed by virtual index bits of the current instruction address.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating a drowsy cache using a Dynamic Voltage Scaling (DVS);

FIG. 2 is a graph illustrating a comparative result of power consumption of a regular cache and a drowsy cache;

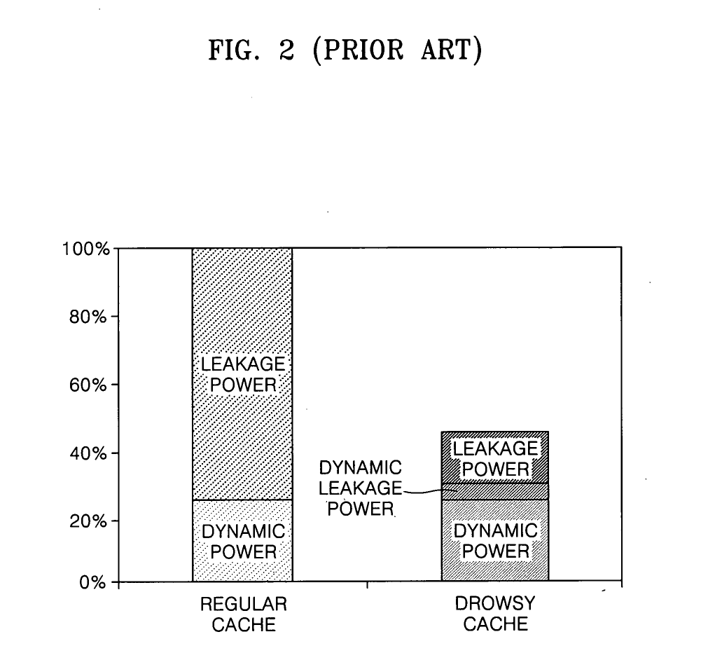

FIG. 3 is a view illustrating a controller for an instruction cache and an instruction TLB according to a preferred embodiment of the present invention;

FIG. 4 is a view illustrating a result of comparing a fetch cycle of a conventional processor core and a fetch cycle of a processor core of FIG. 3;

FIG. 5 is a detailed view illustrating a branch predictor of FIG. 3;

FIG. 6 is a detailed view illustrating a branch target buffer of FIG. 3; and

FIG. 7 is a flowchart illustrating a method of controlling an instruction cache and an instruction TLB according to an embodiment of the present invention.

### DETAILED DESCRIPTION OF THE INVENTION

The attached drawings for illustrating preferred embodiments of the present invention are referred to in order to gain a sufficient understanding of the present invention, the merits thereof, and the objectives accomplished by the implementation of the present invention.

Hereinafter, the present invention will be described in detail by explaining preferred embodiments of the invention with reference to the attached drawings. Like reference numerals in the drawings denote like elements.

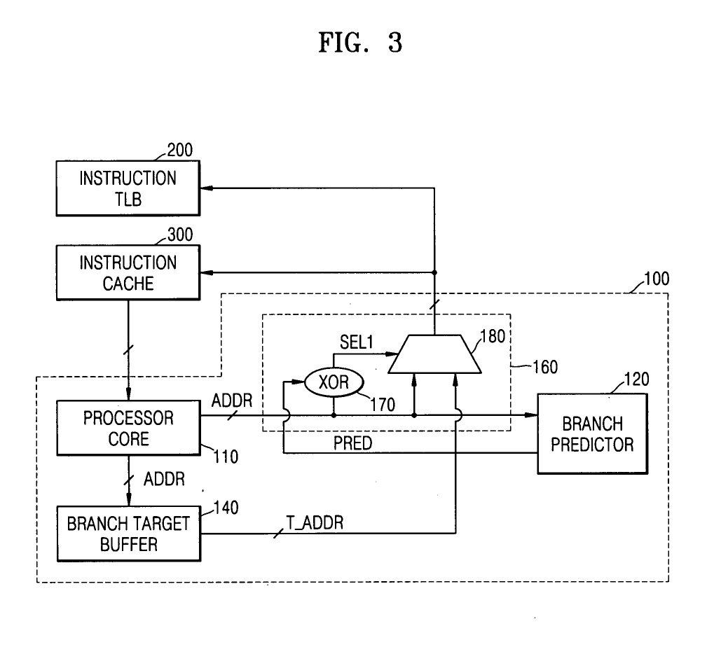

FIG. 3 is a view illustrating a controller for an instruction cache and an instruction TLB according to a preferred embodiment of the present invention.

The controller 100 for the instruction cache and the instruction TLB includes a processor core 110, a branch predictor 120, a Branch Target Buffer (BTB) 140, and an address selection unit 160. The processor core 110 may be hereinafter referred to as a Central Processing Unit (CPU).

The processor core 110 transmits an address (ADDR) for a current instruction to the branch predictor 120, and concurrently transmits the address (ADDR) for the current instruction to the branch target buffer 140. At this time, it is assumed that a previous instruction of the current instruction is not a branch instruction. This is because when an application program is actually executed by the processor core 110, a probability of the absence of the branch instruction is more than ten times of a probability of the existence of the branch instruction.

The branch predictor 120 performs a branch prediction for the current instruction address (ADDR) to output a final branch prediction value (PRED). The branch predictor 120 can perform the branch prediction before one cycle. This is because since the previous instruction of the current instruction is not the branch instruction, addresses stored in a global history register included in the branch predictor 120 and entries of a branch prediction table are not updated, and two sequential entries included in one line of the branch prediction table are indexed by one index value.

The branch target buffer 140 performs a branch target address prediction for the current instruction address (ADDR) to output a prediction target address (T_ADDR). The branch target buffer 140 can perform the branch target address prediction before one cycle. This is because since the previous instruction of the current instruction is not the branch instruction, target addresses stored in a branch target table included in the branch target buffer 140 are not updated, and two sequential entries included in one line of the branch target table are indexed by virtual index bits of an address for one instruction.

The address selection unit 160 includes an exclusive OR gate (XOR) 170 and a multiplexer 180. The address selection unit 160 selects and outputs one of the prediction target address (T_ADDR) and the address (ADDR) of the sequential current instruction in response to the final branch prediction value (PRED) and a Least Significant Bit (LSB) of the current instruction address where a branch prediction result of the branch predictor is not “taken”.

The XOR 170 performs an exclusive OR operation on the final branch prediction value (PRED) and the LSB of the current instruction address (ADDR) to output a selection value (SEL1).

The multiplexer 180 outputs one of the prediction target address (T_ADDR) and the address (ADDR) of the sequential current instruction in response to the selection value (SEL1). The address outputted from the multiplexer 180 wakes up a corresponding cache line of an instruction TLB 200 and a corresponding cache line of an instruction cache 300. Meanwhile, the address outputted from the multiplexer 180 can also wake up a corresponding sub-bank of the instruction TLB 200 and a corresponding sub-bank of the instruction cache 300. The term sub-bank refers to a set of cache lines.

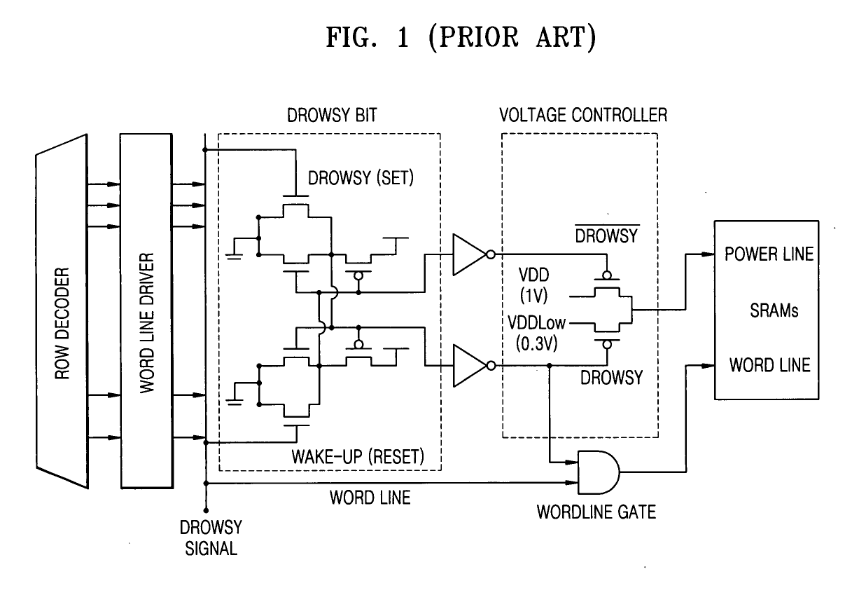

The instruction TLB 200 and the instruction cache 300 use the dynamic voltage scaling described in FIG. 1. The processor core 110 fetches an instruction when the instruction outputted respectively from the cache line of the instruction TLB 200 woken up and the cache line of the instruction cache 300 woken up is tag-matched.

Accordingly, the branch prediction and the branch target address prediction are performed before one cycle, and the controller for the instruction cache and the instruction TLB, according to the present invention, can prevent a wake-up penalty of the instruction cache and the instruction TLB, which use the dynamic voltage scaling.

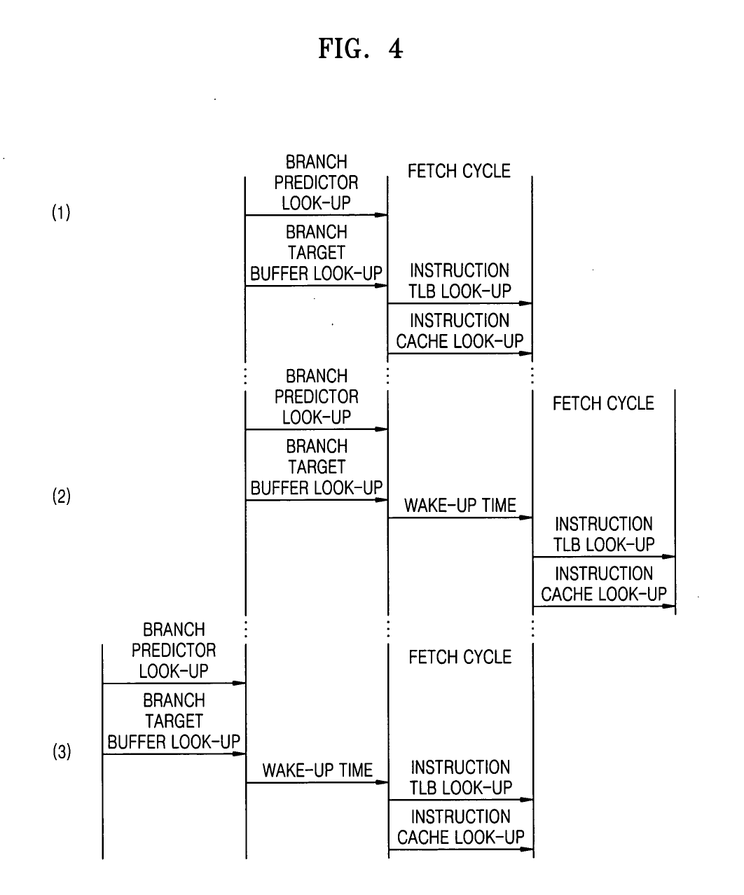

FIG. 4 is a view illustrating a result of comparing a fetch cycle of a conventional processor core and a fetch cycle of the processor core of FIG. 3.

Referring to FIG. 4, a first case illustrates a fetch cycle of the processor core when the instruction cache and the instruction TLB do not use the dynamic voltage scaling. A second case illustrates a fetch cycle of the processor core when the instruction cache and the instruction TLB use the dynamic voltage scaling, but the inventive controller is not used. A third case illustrates a fetch cycle of the processor core when the instruction cache and the instruction TLB use the dynamic voltage scaling and the inventive controller is used.

In the second case, the wake-up penalty of one cycle is generated, but in the third case, since a branch predictor look-up and a branch target buffer look-up are previously performed before one cycle, the wake-up penalty of one cycle is not generated.

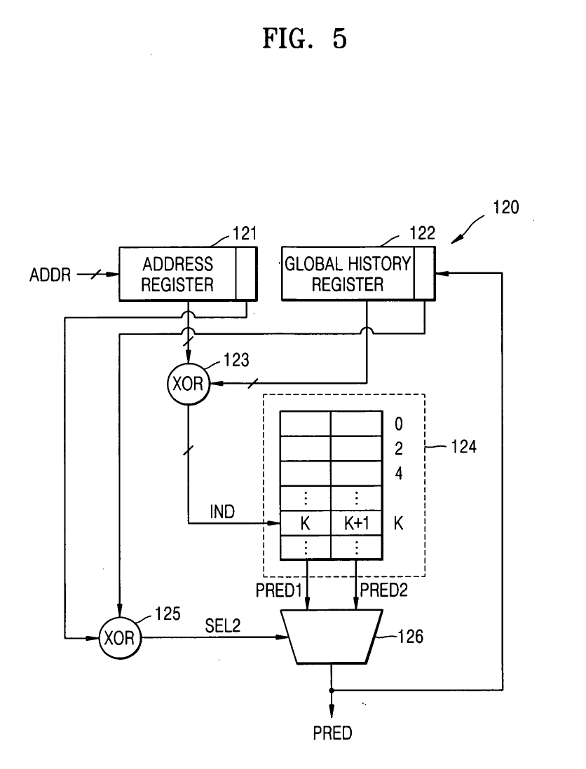

FIG. 5 is a detailed view illustrating the branch predictor of FIG. 3.

Referring to FIG. 5, the branch predictor 120 includes an address register 121 a global history register 122, a first XOR 123, a branch prediction table 124, a second XOR 125, and a multiplexer 126.

The first XOR 123 performs an exclusive OR operation on the current instruction address stored in the address register 121 and the address stored in the global history register 122 to output an index value (IND). The index value (IND) indexes specific entries (for example, K and K+1) of the branch prediction table 124. The addresses stored in the global history register 122 are past branch prediction values for previous branch instructions.

The branch prediction table 124 has the two sequential entries arranged in one line so that the two entries (K, K+1) can be selected by one index value (IND). Accordingly, in the case where the previous instruction of the current instruction is not the branch instruction, but is the sequential instruction (that is, in case where the address of the previous instruction of the current instruction is different from the current instruction address (ADDR) only in the LSB), the addresses stored in the global history register 122 and the entries of the branch prediction table 124 are not updated. Therefore, the global history and the entries of the branch prediction table 124, which are used to perform the branch prediction for the address of the current instruction, are the same as the global history and the entries of the branch prediction table 124, which are used to perform the branch prediction for the address of the previous instruction. As a result, the entries, which are indexed by a combination of the address of each instruction and the global history, exist at one line of the branch prediction table 124. The entries can be concurrently indexed by one index value (IND). Accordingly, before the branch prediction for the address of the previous instruction is ended, the branch prediction can be initiated for the current instruction address one cycle early. Meanwhile, a description for relation between the next instruction of the current instruction and the current instruction is similar to the above description for relation between the previous instruction and the current instruction.

Accordingly, the branch predictor 120 can perform the branch prediction for the current instruction address (ADDR) one cycle early.

Meanwhile, the LSB of the entries (K, K+1) selected from the branch prediction table 124 is outputted as the branch prediction values (PRED1, PRED2) for the current instruction address (ADDR). For example, one of the branch prediction values (PRED1, PRED2) can be used as the branch prediction value for the current instruction address, and the other can be used as the branch prediction value for the next instruction address.

The second XOR 125 performs the exclusive OR operation on the LSB of the current instruction address (ADDR) stored in the address register 121 and the LSB of the address stored in the global history register 122 to output a selection value (SEL2).

The multiplexer 126 outputs one of the branch prediction values (PRED1, PRED2) as the final branch prediction value (PRED), in response to the selection value (SEL2). For example, in case where the final branch prediction value is “1”, the branch prediction for the current instruction address is “taken”. In the case where the final branch prediction value is “0”, the branch prediction for the current instruction address is “untaken”. The final branch prediction value (PRED) is used to update the addresses stored in the global history register 122 and the entries of the branch prediction table 124, for the next branch prediction.

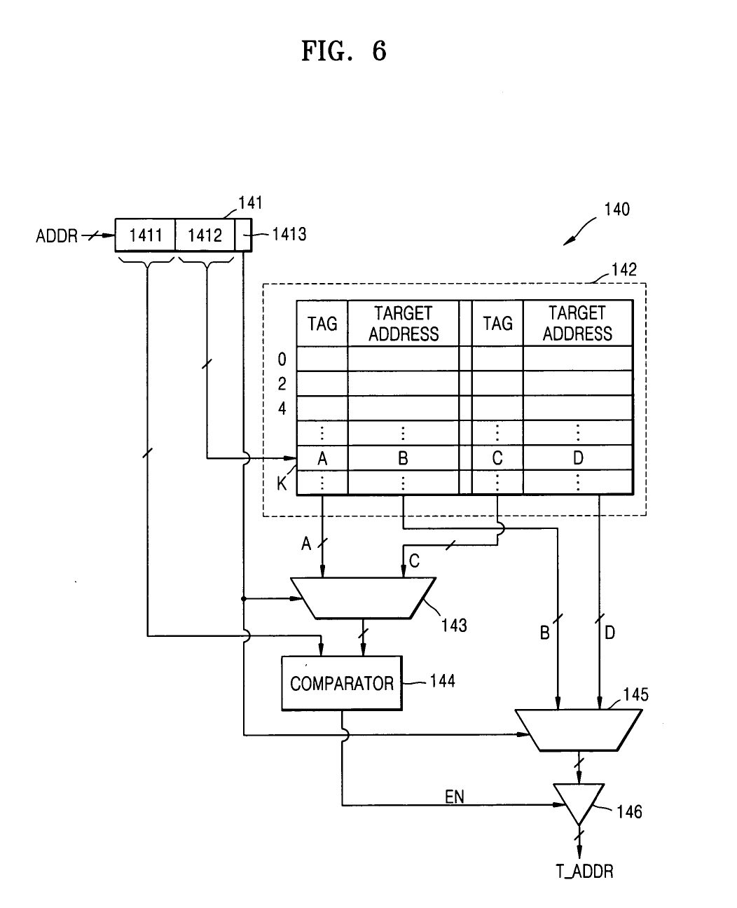

FIG. 6 is a detailed view illustrating the branch target buffer of FIG. 3.

Referring to FIG. 6, the branch target buffer 140 includes an address register 141, a branch target table 142, a first multiplexer 143, a comparator 144, a second multiplexer 145, and a buffer 146.

The branch target table 142 stores the target addresses (for example, B and D) for addresses of the previous branch instructions, and the target tags (for example, A and C) corresponding to the target addresses.

The virtual index bits 1412 of the current instruction address (ADDR) stored in the address register 141 index the two sequential entries (for example, [A,B], [C,D]) included in one line of the branch target table 142. Accordingly, in the case where the previous instruction of the current instruction is not the branch instruction, but is the sequential instruction (that is, in case where the address of the previous instruction of the current instruction is different from the current instruction address (ADDR) only in LSB), the entries of the branch target table 142 are not updated. Therefore, the entries of the branch target table 142, which are used to perform the branch target address prediction for the current instruction address, are the same as the entries of the branch target table 142, which are used to perform the branch target address prediction for the previous instruction address. As a result, the entries indexed by the virtual index bits 1412 of the address for each instruction exist at one line of the branch target table 142. The entries can be concurrently indexed by the virtual index bits (1412). Accordingly, before the branch target address prediction for the previous instruction address is ended, the branch target address prediction for the current instruction address can be initiated one cycle early. Meanwhile, a description for relation between the next instruction of the current instruction and the current instruction is similar to the above description for relation between the previous instruction and the current instruction.

Accordingly, the branch target buffer 140 can perform the branch target address prediction one cycle early.

The first multiplexer 143 outputs one of the target tags (A, C) outputted from the branch target table 142, in response to the LSB 1413 of the current instruction address stored in the address register 141.

The comparator 144 compares physical tag bits 1411 of the current instruction address (ADDR) stored in the address register 141 with the target tag outputted from the first multiplexer 143, to output an enable signal (EN). If the comparative value is consistent, the enable signal (EN) is activated.

The second multiplexer 145 outputs one of the target addresses (B, D) outputted from the branch target table 142, in response to the LSB 1413 of the current instruction address (ADDR) stored in the address register 141.

The buffer 146 buffers the target address outputted from the second multiplexer 145 in response to the activated enable signal (EN) to output the prediction target address (T_ADDR).

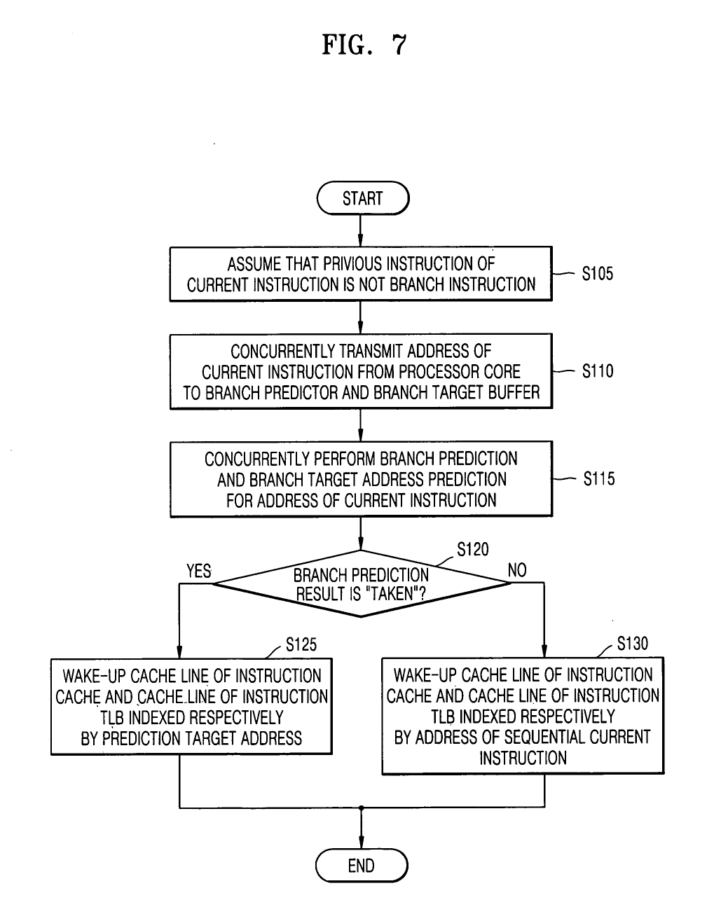

FIG. 7 is a flowchart illustrating a method of controlling the instruction cache and the instruction TLB according to an embodiment of the present invention.

The controlling method of the instruction cache and the instruction TLB of FIG. 7 can be applied to the controller for the instruction cache and the instruction TLB of FIG. 3.

According to an assumption step (S105), it is assumed that the previous instruction of the current instruction is not the branch instruction.

According to a transmission step (S110), the address of the current instruction is concurrently transmitted from the process core to the branch predictor and the branch target buffer.

According to a prediction step (S115), the branch prediction and the branch target address prediction can be concurrently performed for the address of the current instruction. The prediction step (S115) can be performed one cycle early. This is because since the previous instruction of the current instruction is not the branch instruction, the addresses stored in the global history register included in the branch predictor and the entries of the branch prediction table are not updated, and the two sequential entries included in one line of the branch prediction table are indexed by one index value. Further, entries of the branch target table included in the branch target buffer are not updated, and the two sequential entries included in one line of the branch target table are indexed by the virtual index bits of the address for one instruction.

According to a determination step (S120), it is determined whether the branch prediction result is “taken”. If it is determined in the determination step (S120) that the branch prediction result is “taken”, a first wake-up step (S125) is performed. If it is determined that the branch prediction result is not “taken” (that is, if it is determined that the address of the current instruction is not the address of the branch instruction, or that the branch prediction result for the current instruction address is “untaken” (or “not-taken”)), a second wakeup step (S130) is performed.

According to the first wake-up step (S125), the cache line of the instruction cache and the cache line of the instruction TLB indexed respectively by the prediction target address are woken up. Meanwhile, in a wake-up step (S125), the sub-bank of the instruction cache and the sub-bank of the instruction TLB indexed respectively by the prediction target address can be also woken up. The term sub-bank refers to the set of the cache lines.

According to a second wake-up step (S130), the cache line of the instruction cache and the cache line of the instruction TLB indexed respectively by the address of the sequential current instruction are woken up. Meanwhile, in the second wake-up step (S130), the sub-bank of the instruction cache and the sub-bank of the instruction TLB indexed respectively by the address of the sequential current instruction can be also woken up.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A controller for an instruction cache and an instruction TLB (Translation Look-aside Buffer), the controller comprising:
a processor core outputting an address of a current instruction;
a branch predictor performing a branch prediction of the outputted current instruction address to output a final branch prediction value;
a branch target buffer predicting a branch target address of the outputted current instruction address at the same time as the branch predictor performs the branch prediction, to output a prediction target address; and
an address selection unit selecting and outputting one of the prediction target address and the current instruction address where a branch prediction result is not “taken”,
wherein the branch prediction and the branch target address prediction for the current instruction address are initiated, on the assumption that a previous instruction of the current instruction is not a branch instruction, before a branch prediction and a branch target address prediction for an address of the previous instruction of the current instruction are ended, and
wherein the address outputted from the address selection unit wakes up corresponding cache lines of the instruction cache and the instruction TLB, which use a dynamic voltage scaling.

2. The controller of claim 1, wherein the address outputted from the address selection unit wakes up corresponding sub-banks of the instruction cache and the instruction TLB, which use the dynamic voltage scaling.

3. The controller of claim 1, wherein the address selection unit operates in response to a least significant bit of the current instruction address and the final branch prediction value.

4. The controller of claim 3, wherein the address selection unit comprises:
an exclusive OR gate performing an exclusive OR operation on the least significant bit of the current instruction address and the final branch prediction value, to output a selection value; and
a multiplexer selecting and outputting one of the current instruction address wherein the branch prediction result is not “taken” and the prediction target address, in response to the selection value.

5. The controller of claim 1, wherein the branch predictor comprises:
a global history register storing past branch prediction values for addresses of previous branch instructions;
a first exclusive OR gate performing an exclusive OR operation on the current instruction address and the address stored in the global history register, to output an index value;
a branch prediction table storing branch prediction values for the addresses of the past branch instructions, and outputting the branch prediction values for the current instruction address indexed by the index value;
a second exclusive OR gate performing an exclusive OR operation on a least significant bit of the current instruction address and a least significant bit of the address stored in the global history register, to output a selection value; and
a multiplexer outputting one of the branch prediction values as the final branch prediction value, in response to the selection value.

6. The controller of claim 5, wherein the branch predictor further comprises an address register storing the current instruction address.

7. The controller of claim 5, wherein two sequential entries included in one line of the branch prediction table are indexed by the index value.

8. The controller of claim 1, wherein the branch target buffer comprises:
a branch target table storing target addresses for the addresses of the previous branch instructions indexed by virtual index bits of the current instruction address, and target tags corresponding to the target addresses;
a first multiplexer outputting one of the target tags indexed by the virtual index bits, in response to a least significant bit of the current instruction address;
a comparator comparing physical tag bits of the current instruction address with the outputted one of the target tags, to output an enable signal;
a second multiplexer outputting one of the target addresses indexed by the virtual index bits, in response to the least significant bit of the current instruction address; and
a buffer buffering the outputted one of the target addresses in response to the activation of the enable signal, to output the buffered target address as the prediction target address.

9. The controller of claim 8, wherein the branch target buffer further comprises an address register storing the current instruction address.

10. The controller of claim 8, wherein two sequential entries included in one line of the branch target table are indexed by the virtual index bits.

11. A method of controlling an instruction cache and an instruction TLB (Translation Look-aside Buffer), the method comprising:
(a) assuming that a previous instruction of a current instruction is not a branch instruction;
(b) concurrently performing a branch prediction and a branch target address prediction for an address of the current instruction;
(c) determining whether a branch prediction result of (b) is “taken”;
(d) if it is determined in (c) that the branch prediction result is “taken”, waking up a cache line of the instruction cache and a cache line of the instruction TLB that is indexed by a prediction target address, the prediction target address being a result of the branch target address prediction of (b); and
(e) if it is determined in (c) that the branch prediction result is not “taken”, waking up a cache line of the instruction cache and a cache line of the instruction TLB that is indexed by an address of a sequential current instruction,
wherein the branch prediction and the branch target address prediction for the current instruction address are initiated before a branch prediction and a branch target address prediction for an address of the previous instruction are ended, and
wherein the instruction cache and the instruction TLB use a dynamic voltage scaling.

12. The method of claim 11, further comprising: concurrently transmitting the current instruction address from a processor core to a branch predictor performing the branch prediction and to a branch target buffer performing the branch target address prediction.

13. The method of claim 11, wherein in (d), a sub-bank of the instruction cache and a sub-bank of the instruction TLB indexed respectively by the prediction target address are woken up, and
in (e), a sub-bank of an instruction cache and a sub-bank of the instruction TLB indexed respectively by the address of the sequential current instruction are woken up.

14. The method of claim 11, wherein two sequential entries included in one line of a branch prediction table used for performing the branch prediction of (b) are indexed by one index value.

15. The method of claim 11, wherein two sequential entries included in one line of a branch prediction table used for performing the branch target address prediction of (b) are indexed by virtual index bits of the current instruction address.
